(19) United States
(12) Patent Application Publication
(10) Pub. No.: US 2016/0137013 A1
(43) Pub. Date: May 19, 2016

(54) Safety guard

(71) Applicant: SAFE PROMOTION LIMITED, Tauranga (NZ)

(72) Inventors: Martin Ernst Wiersma, Tauranga (NZ); Joanne Aileen Wiersma, Tauranga (NZ)

(21) Appl. No.: 14/851,269

(22) Filed: Sep. 11, 2015

(30) Foreign Application Priority Data
Sep. 12, 2014 (NZ) 631692

(51) Int. Cl. B60D 1/60

(52) U.S. Cl. CPC B60D 1/605

(57) ABSTRACT

A safety guard for a tow bar has a first arm engageable with the tow bar and a second arm engageable with the tow bar. Each arm is independently pivotable with respect to the tow bar so that the safety guard can be angle adjusted to accommodate tow bars which extend to different lengths from the vehicle. Each arm is further formed so that when in use the safety guard present a shield around the tow bar to prevent people walking into the tow bar.

### CROSS-REFERENCE TO RELATED APPLICATIONS

This application claims the benefit of New Zealand Patent Number: 631692, filed Sep. 12, 2014. The entire disclosure of this prior application is hereby incorporated by reference.

### FIELD OF INVENTION

This invention relates to a safety guard. A preferred from of the invention relates to a safety guard for a tow bar.

### BACKGROUND

Motor vehicle tow bars jut out from the vehicle and are often accidentally walked into in the dark or in poor light, or as a result of simple absent mindedness, causing painful injuries to the legs. It is an object of a preferred form of the present invention to go at least some way towards addressing this problem. While this is an object of a preferred embodiment, it should not be seen as a limitation on the scope of the invention as claimed. The object of the invention per se is simply to provide the public with a useful choice.

### SUMMARY OF THE INVENTION

According to one aspect of the invention there is provided a safety guard for a tow bar having:

a first arm engageable with the tow bar; and

a second arm engageable with the tow bar;

each arm being independently pivotable with respect to the tow bar so that the safety guard can be angle adjusted to accommodate tow bars which extend to different lengths from the vehicle, each arm further formed so that when in use the safety guard present a shield around the tow bar to prevent people walking into the tow bar.

Preferably the guard is formed such that when it is installed on a tow bar the tow bar remains free for normal use.

Preferably each arm contains an aperture adapted to engage with a/the base of a tow ball of the tow bar.

Preferably the arms are substantially winged shape.

Preferably the arms are substantially formed form a resilient material.

Preferably the arms are substantially formed from plastic.

Preferably the arms are substantially coated in a luminescent material.

Preferably each arm has a plate formed from a substantially metallic material, the plate having an aperture adapted to engage with a base of a/the tow ball of the tow bar.

### BRIEF DESCRIPTION OF THE DRAWINGS

Some preferred embodiments of the invention will now be described by way of example and with reference to the accompanying drawings, of which:

FIG. 1 is a perspective view illustrating a safety guard for use with a tow bar;

FIG. 2 is a top plan view of an arm which forms part of the safety guard;

FIG. 3 is a top view of a plate which forms part of the safety guard's arm;

FIG. 4 is a side view of the safety guard;

FIG. 5 is a top plan view illustrating the safety guard's adjustability;

FIG. 6 is a top view plan view of an arm that forms part of a second embodiment of safety guard;

FIG. 7 is a cross-sectional view of the arm of FIG. 6;

FIG. 8 is a top plan view of an arm that forms part of a second embodiment of safety guard;

FIG. 9 is a top plan view illustrating the safety guard's adjustability;

FIG. 10A is a side view of the second embodiment of safety guard;

FIG. 10B is a second side view of the second embodiment of safety guard; and

FIG. 10C is a perspective view of the second embodiment of safety guard.

### DETAILED DESCRIPTION

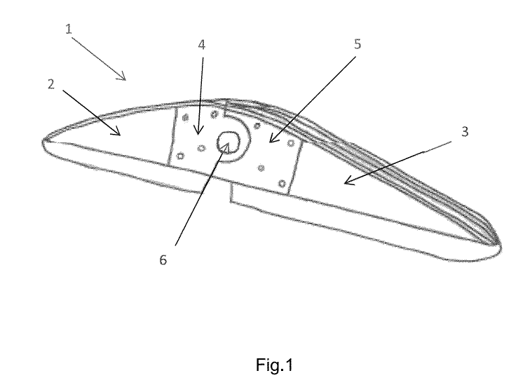

As shown in FIG. 1, the safety guard 1 has two arms 2 and 3 each having a plate 4, 5 both of which have an aperture 6 for removably fitting around the base of a tow ball (not shown).

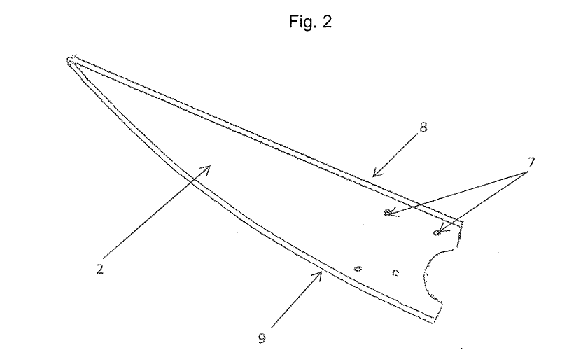

FIG. 2 shows one arm 2 with its plate 4 removed. The arm 2 contains apertures 7 which enable the plate 4 to be attached with screws or the like. In some embodiments the arm 2 does not have a plate 4 and instead has an aperture which can fit around the base of a tow ball (not shown). As indicated, the arm 2 is generally a wing shape with a generally straight edge 8 on one side so that it can sit flush against the rear panel or bumper of a vehicle when in use. The opposite edge 9 is curved to guide people away from walking into the tow bar (not visible). In a preferred embodiment of the invention the arms are made from plastic or a resilient material such as rubber and are brightly coloured (e.g. orange) to aid with visibility. In some embodiments of the invention the arms are coated with luminescent materials to that they are visible at night or in low light conditions.

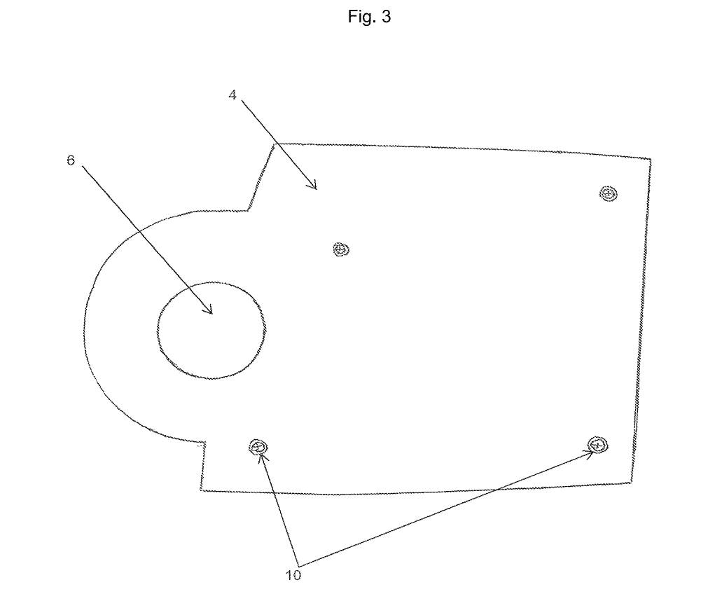

FIG. 3 shows one of the plates 4 when it has been removed from the associated arm 2. The plate 4 is preferably made from a metallic material such as stainless steel and is approximately 2 mm thick. The plate 4 contains apertures 10 so that it can be fastened to the arm 2. The plate 4 also has the larger aperture 6 which can fit around the base of a tow ball and allows the plate 4 and arm 2 to pivot collectively with respect to the tow ball. As the plates 4, 5 are fitted around the base of the tow ball this allows the ball to be fully accessible for a towing connection.

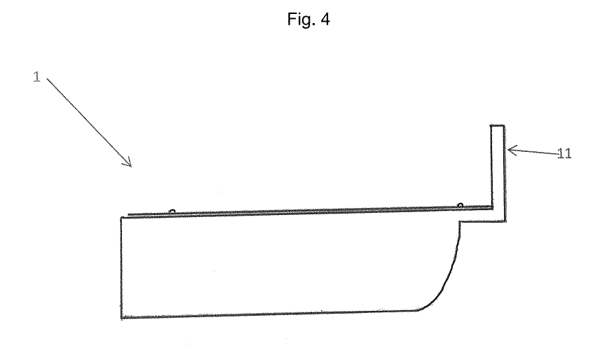

FIG. 4 shows that the arm 2 has a lip 11 on the outer side to provide a non-injurious blunt contact surface should someone walk into it. The lip 11 also adds rigidity or stiffness to the arm 2.

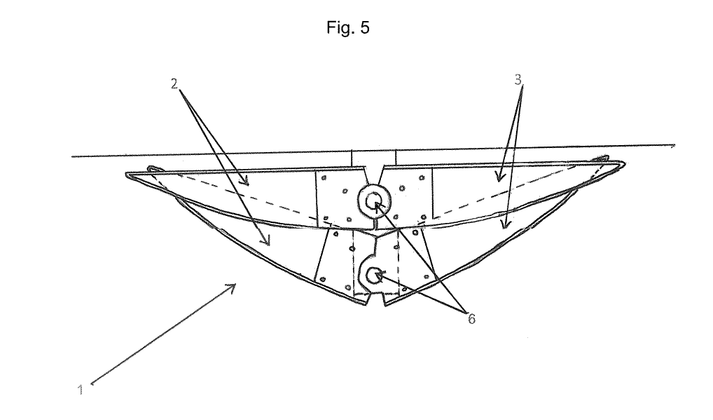

FIG. 5 shows that the guard 1 can be angle adjusted by pivoting each of the arms 2, 3 with respect to the tow ball. This allows the guard 1 to accommodate tow bars which extend to different lengths from the vehicle. In a preferred embodiment of the invention the guard 1 can be adjusted to accommodate tow bars which extend up to 200 mm from the back of a vehicle. As indicated, the outer ends of each arm 2, 3 are free to contact the back of a vehicle—they are supported in a cantilever fashion by way of the plates 4 and need not be fastened themselves.

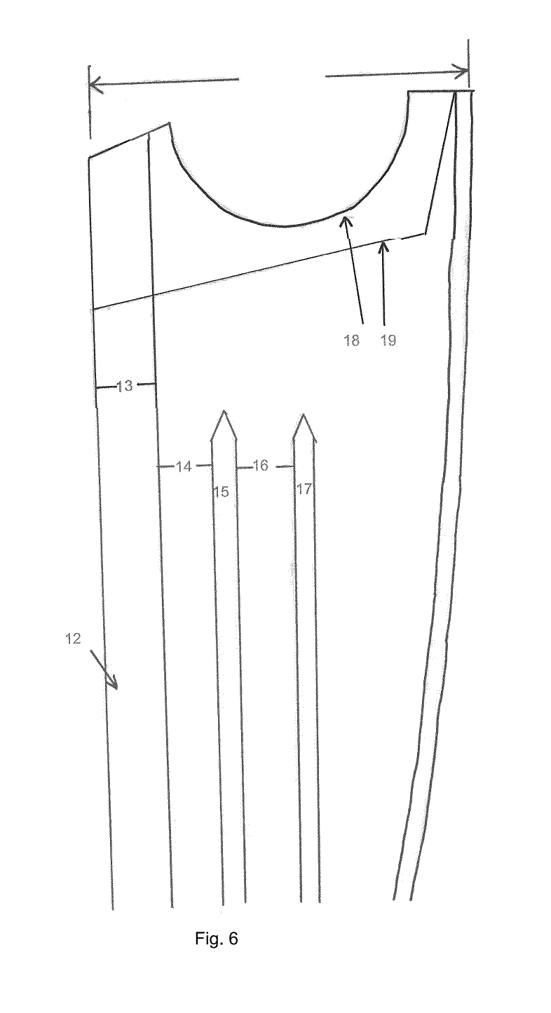

FIG. 6 shows part of the arm or wing of a second embodiment of safety guard. This arm includes a side that faces the read of the vehicle 12. The area bounded by line 19 is the underside of the wing and the area bounded by line 18 is the top side of the wing. As can be seen in FIG. 6 the two areas are different forming a stepped area between them. The underside and top side of the wing are formed from plastic or other resilient material.

In one embodiment the wing includes ridges 15 and 17. The ridges may be any suitable size, for example the ridges may be 5 mm wide and spaced 15 mm apart and 15 mm from upper lip 13 facing the back of the vehicle.

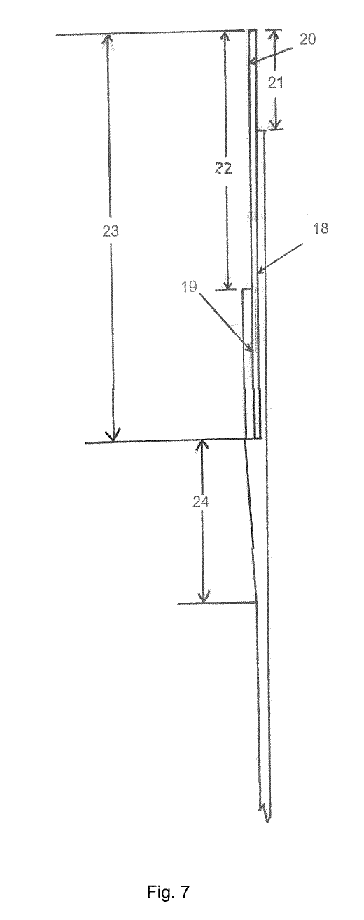

FIG. 7 is a cross sectional view of the arm of FIG. 6. The arm includes a portion 20 that fits around the base of a tow ball on a tow bar, underside 19 and upper side 18. Portion 20 may be formed from metal. In one example upper side 18 begins a distance 21 from the end of portion 20. For example, this distance may be 32 mm. Upper side 18 and under side 19 may be about 3 mm thick on either side of portion 20. Under side 19 may begin a distance 22 from the edge of portion 20. In one example this distance is about 84 mm. As shown the cross section, the thickness of the arm may change along the length of the arm. Area 24 shows one place where the arm thickness reduces as the distance from the tow ball receiving end increases. Portion 20 may be formed from any suitable material. For example, portion 20 may be formed from 2 mm thick stainless steel.

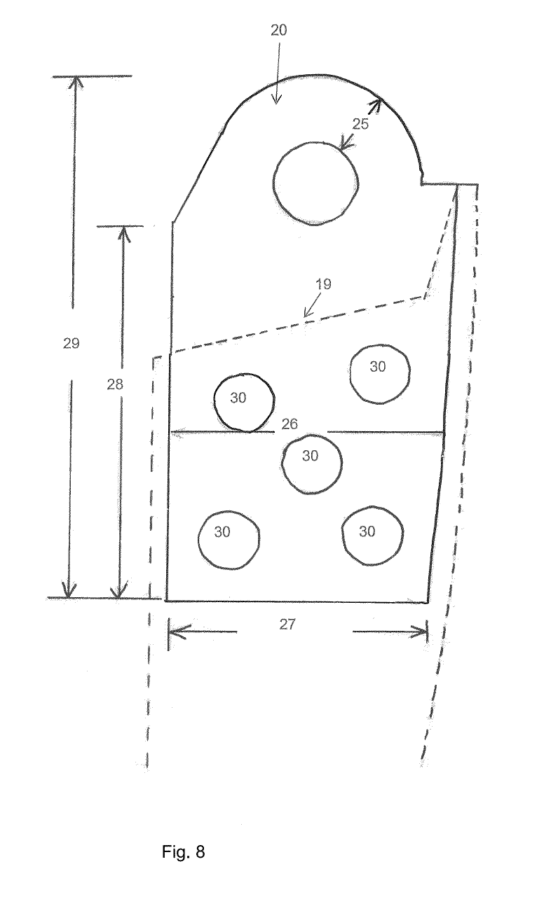

FIG. 8 is a top plan view of an arm forming part of the safety guard of a second embodiment of the invention showing the tow ball receiving portion 20 and the underside 19. Example dimensions of the safety guard include a width 25 around the tow ball receiving part of about 19 mm, width 26 of the arm of about 83 mm. At the arm extends from the tow ball receiving part the width of the arm narrows. Width 27 may be about 80 mm for example. The distance from the end of the ball receiving portion 20 to the start of the ball receiving opening 28 may be about 117 mm and the length of the ball receiving portion may be about 161 mm. It should be noted that all dimensions given are by way of example only and are intended to be illustrative and not limiting. The width and length of the safety guard can be altered to suit the vehicle to which the safety guard will be attached. The ball receiving portion 20 may include a plurality of openings 30. In use, when the safety guard is formed one side of the arm may be moulded and then the ball receiving portion fitted before the other side of the arm is moulded. If the arm is formed of plastic and injection moulded then the ball receiving portion 20 is placed into the mould while the plastic is still hot. The plastic then flows into the holes securing the ball receiving portion in the arm of the safety guard.

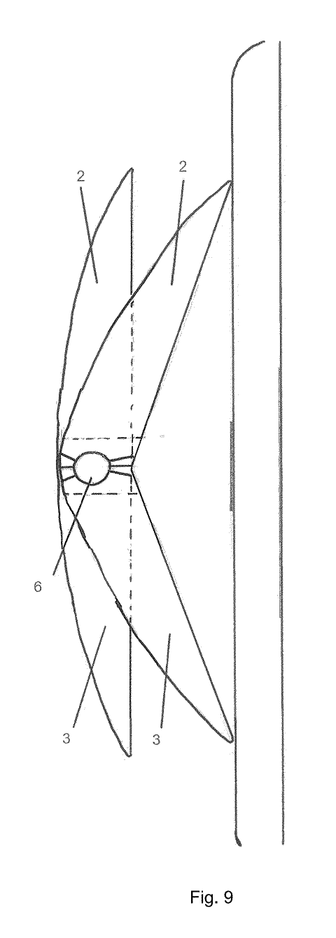

FIG. 9 shows that the second embodiment of guard 1 can be angle adjusted by pivoting each of the arms 2, 3 with respect to the tow ball. This allows the guard 1 to accommodate tow bars which extend to different lengths from the vehicle. In a preferred embodiment of the invention the guard 1 can be adjusted to accommodate tow bars which extend up to 200 mm from the back of a vehicle. As indicated, the outer ends of each arm 2, 3 are free to contact the back of a vehicle—they are supported in a cantilever fashion by way of the plates 4 and need not be fastened themselves.

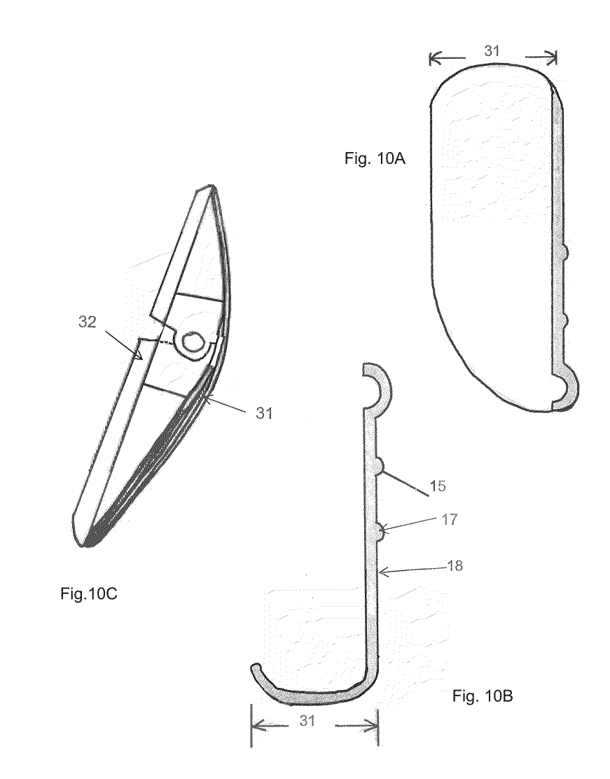

FIGS. 10A, 10B and 10C show different views of the safety guard of the second embodiment of the invention. FIGS. 10A and 10B show side views showing raised area 15 and 17 on the top of the safety guard and overhang 31 of the safety guard. The overhang provides a surface that spreads any impact of a person walking into the safety guard to prevent or minimise injury.

FIG. 10C shows a perspective view of the second embodiment of safety guard. As well as being provided with overhang 31, the safety guard may also be provided with an upper lip 32. The upper lip 32 sits on the vehicle side of the safety guard when the safety guard positioned on a car. Upper lip 32 is sized so that it does not obscure the vehicle license plate. In some embodiment advertising may be provided on the upper lip. In other embodiment the upper lip may be capable of supporting advertising or branding.

As will be appreciated, when the safety guard is fitted it prevents people walking into the tow bar. It serves as a barrier. Because of its long length, and because the arms are plastic or rubber, walking into it is far less likely to cause injury than if the safety guard weren't in place. The curvature of the arms tends to visually guide people away from the tow bar, to lessen the risk of someone even walking into the safety guard.

While some preferred forms of the invention have been described by way of example it should be appreciated that modifications and improvements can occur without departing from the scope of the following claims.

What I claim is:

1. A safety guard for a tow bar having:
a first arm engageable with the tow bar; and
a second arm engageable with the tow bar;
each arm being independently pivotable with respect to the tow bar so that the safety guard can be angle adjusted to accommodate tow bars which extend to different lengths from the vehicle, each arm further formed so that when in use the safety guard present a shield around the tow bar to prevent people walking into the tow bar.

2. A safety guard as claimed in claim 1, formed such that when it is installed on a tow bar the tow bar remains free for normal use.

3. A safety guard as claimed in claim 1, wherein each arm contains an aperture adapted to engage with a/the base of a tow ball of the tow bar.

4. A safety guard as claimed in claims 1, wherein the arms are substantially winged shape.

5. A safety guard as claimed in claim 1, wherein the arms are substantially formed form a resilient material.

6. A safety guard as claimed in claim 1, wherein the arms are substantially formed from plastic.

7. A safety guard as claimed in claim 1, wherein the arms are substantially coated in a luminescent material.

8. A safety guard as claimed in claim 1, wherein each arm has a plate formed from a substantially metallic material, the plate having an aperture adapted to engage with a base of a/the tow ball of the tow bar.
